(19) United States
(12) Patent Application Publication
(10) Pub. No.: US 2020/0079457 A1
(43) Pub. Date: Mar. 12, 2020

(54) FOOT PLATFORMS WITH SUSPENSIONS FOR VEHICLES USED WHILE STANDING

(71) Applicant: Haitao Fan, McLean, VA (US)

(72) Inventor: Haitao Fan, McLean, VA (US)

(73) Assignee: Haitao Fan, McLean, VA (US)

(21) Appl. No.: 16/125,698

(22) Filed: Sep. 8, 2018

(51) Int. Cl. B62J 25/00; B62K 11/00; B62K 1/00; B62J 99/00

(52) U.S. Cl. CPC B62J 25/00; B62K 11/007; B62K 2201/06; B62J 99/00; B62K 1/00

(57) ABSTRACT

A platform having a suspension system may include a platform with a column or parallel columns of any cross section shape rigidly protruding from one side of the platform, a base having a pipe for each column to slide along the inside of the pipe, at least one leaf spring between the base and the platform for absorbing shocks. The relative positions of these parts are kept by sliders, slider guides and position limiters so that the platform can move only in one dimension generally parallel to the pipe. Various embodiments are disclosed for using as foot platforms in one or two-wheeled self-balancing vehicles. These embodiments are simple, compact and light modules to be adapted easily in such vehicles, without affecting the balancing and steering. Some embodiments enable users to change leaf springs and adjust damping. Embodiments of foldable platform are also disclosed.

### CROSS REFERENCE TO RELATED APPLICATIONS

Not Applicable.

### BACKGROUND OF THE INVENTION

### Field

This disclosure relates to methods for isolating a platform from shocks. More specifically, the disclosed embodiments relate to foot platforms with suspension systems to be used in one-wheeled or two-wheeled self-balancing vehicles.

### Background

There are one-wheeled or two-wheeled self-balancing vehicles, whose drivers stand on platforms while driving. In the following, such vehicles are called “the vehicles”. Examples of prior arts of the vehicles are “Segways”, hoverboards, electric unicycles, and one-wheeled skateboards. They are disclosed in U.S. Pat. Nos. 6,302,230, 8,616,313 B2, 8,738,278 B2 8,807,250 B2, 9,101,817 B2 and many others. As an example, FIG. 1 shows a prior art electric unicycle 10. The driver of the electric unicycle 10 stands on foot platform 12 when driving. One valuable characteristics of such vehicles is their portability.

If without shock absorbers, road imperfections will cause discomfort, or worse, may overwhelm the self-balancing of the vehicles, throw riders off the vehicle, resulting in injury.

A need exists for the vehicles to have shock absorbers for isolating riders from shocks caused by uneven road. Such suspensions must satisfy the following requirements: The suspension should
R1) allow motion only in directions generally perpendicular to the foot platform, no matter what the rider's foot does;
R2) be thin relative to the foot platform, compact and light in weight to keep the vehicles portable;
R3) be inexpensive and reliable;
R4) be easy to be isolated away from battery pack and electronics of the vehicles.

The requirement R1) is necessary because the speed of the vehicle is controlled by the rider's body leaning in the direction of travel. For example, the speed of a self-balancing electric unicycle depends on the horizontal distance in the direction of travel between the center of feet's pressure to the wheel's axle. The rider controls this distance by body leaning. Therefore, unintended change of this distance due to the suspension must be prevented. Thus, the foot platform is allowed to move only in directions generally perpendicular to the foot platform. Requirement R2) is essential since portability is one major advantage of electric unicycle and hoverboards over other vehicles. Requirement R4) is for better reliability because large battery packs, electronics such as control boards, sensors, speakers and their water proof seals are more likely to malfunction with oily heavy duty moving parts nearby. Furthermore, for better stability and maneuverability, heavy parts of an of electric unicycle such as motor and battery packs should be kept near the center. This means that the suspension system should be away from the center region of an electric unicycle.

One group of prior art suspension systems for the vehicles uses coil springs or cylindrical shock absorbers. Those one-wheeled or two-wheeled self-balancing vehicles with such suspension systems are disclosed in U.S. Pat. No. 8,807,250 B2 (Chen), No. 2017/0,267,306 A1 (Chen), U.S. Pat. Nos. 9,962,597 B2 and 10,010,784 B1 (Doerksen et. al.), No. 2017/0,120,139 A1 (Ma) and No. 2017/0,008,590 A1 (Artemev, FIG. 9). There are also numerous patents disclosing prior arts of such kind of suspensions for scooters and skateboards. However, all of them fail to satisfy at least one of the requirements listed above, especially the requirement R1). Cylindrical shock absorbers with coil spring are relatively bulky. Air spring with hydraulic damping are relatively expensive. They either require many moving parts such as rotating arms of parallelograms or a large vertical space to keep the foot platform level and hence not compact enough to fit inside hoverboards. For example, the prior art suspension shown in FIGS. 7 and 8 in both U.S. Pat. Nos. 9,962,597 B2 and 10,010,784 B1 allow the footboard to move forward and backward when absorbing shocks, violating requirement R1). The suspensions shown in FIG. 7 of prior art U.S. Pat. No. 8,807,250 B2 and in No. 2017/0,267,306 A1 occupy the center region of the electric unicycle, which is undesirable as explained in the last paragaph. The suspension disclosed in FIG. 9 of US Pat. No. 2017/0,008,590 A1 also occupies the center region of the electric unicycle. Angular movement of foot platform in US Pat. No. US2017/0,267,306 A1 violates requirement R1).

A prior art of simple suspension for a two-wheeled self-balancing skateboard is disclosed in U.S. Pat. No. 9,999,827 B2. Its suspension element comprises a single spring steel member of the shape similar to a C. The footboard is connected to the upper side of the C. The lower side of the C is connected to the axel of a wheel. There is no damping mechanism in it. Such suspension can cause unintended lean of the footboard, violating requirement R1) to result in interferences with the steering of the vehicle. For the same reason, the suspension disclosed in U.S. Pat. No. 9,821,215 B2 also violates R1).

In prior art 10 shown in FIG. 1, for better portability, the foot platform 12 can be turned to vertical position around the axel 18 when not in use. When replacing the foot platform 12 by a foot platform with a suspension system under the platform, the new platform has to be raised above the pedal base 14. For such a platform with suspension to turn around axel 18 to vertical position, there has to be a large enough gap between the platform and the casing 16 unless the platform itself can be folded. A large gap between the foot plat form and the casing 16 decrease the controllability of the electric unicycle 10 and the safety of the driver's feet.

Therefore, there is a need for a foldable thin plate platform. The foldable foot platform must satisfy requirements that
S1) in complete unfolded position, the thin foot platform is a flat plate with nothing extruding outside of the general surfaces of the platform;
S2) the unfolded platform is strong enough to support a person above;
S3) the unfolded flat position will not change due to vibrations during travel even when the foot above it leaves temporally;
S4) folding and unfolding is done via one push or pull by hand.
   While there are numerous prior art foldable platforms, none of them satisfy these requirements S1-S4).

### BRIEF SUMMARY OF THE INVENTION

Accordingly, the goal of this invention is to provide foot platforms with suspension systems for use in one-wheeled and two-wheeled self-balancing vehicles (“the vehicles”) that overcomes the shortcomings of the prior arts. To achieve this goal, the criterion for proposed embodiments are that they satisfy at least the four requirements R1) to R4) listed in paragraph

An additional criterion is that embodiments proposed must be modules to be adapted easily in the vehicles without much change to existing designs of the vehicles. I further require that it is easy to retrofit existing electric unicycles with these embodiments.

All disclosed embodiments for foot platforms with suspension systems satisfy the criteria listed in last paragraph. The simplest among these embodiments comprises a foot platform, a rectangular column slider rigidly coupled to the platform, a base with a pipe serving as the slide guide for the column, and a leaf spring between the platform and the base for absorbing shocks, and a position limiter to prevent the column from sliding out of the pipe. Other embodiments improve upon this embodiment by adding more features such as more and adjustable damping mechanisms, more sliders and slide guides. These sliders and slider guides make the foot platform more stable while allowing shorter vertical column sliders, resulting in a higher ground clearance for better safety.

It is also an objective of this disclosure to provide embodiments of foldable platforms satisfying requirements S1-S4) listed in paragraph [0009]. Two embodiments of such foldable platforms are proposed. These embodiments of foldable platform are useful in foot platforms with suspension systems for electric unicycles.

One embodiment of foot platform with suspension system specifically designed for electric unicycles has a foldable foot platform. This embodiment is motivated by the need for the embodiment to be turned to vertical position when not in use. All other embodiments of foot platform with suspension systems can also use foldable foot platforms as exemplified by this embodiment.

The attainment of the foregoing and related advantages and features of the disclosure should be more readily apparent to those skilled in the art, after reviewing the following drawings and detailed descriptions.

### BRIEF DESCRIPTION OF THE DRAWINGS

FIG. 1 shows a prior art electric unicycle.

FIG. 2A (side view), FIG. 2B (isometric view from lower right) and FIG. 2C (isometric view from top right) illustrate the first embodiment of the foot platform with suspension.

FIG. 2D is the same view of the first embodiment shown in FIG. 2C with the foot platform and center column slider removed.

FIG. 3A is an isometric view from the lower right of the second embodiment.

FIG. 3B is an isometric view from the top right of the same embodiment shown in FIG. 3A with the foot platform removed.

FIG. 4A (side view), FIG. 4B (isometric view from top right) show the third embodiment of the foot platform with suspension.

FIG. 4C is the same as FIG. 4B except that the foot platform and one screw and its tension spacer are removed.

FIG. 5 is the side view of the fourth embodiment.

FIG. 6 is the side view of the fifth embodiment.

FIG. 7A (isometric view from the top right) and FIG. 7B (parts blowout drawing, same viewing angle as FIG. 7A) show the first embodiment of foldable platform.

FIG. 8A (isometric view from the top right, before assembly) and FIG. 8B (same view as in FIG. 8A, after assembly) show the second embodiment of foldable platform.

FIG. 9A (isometric view from the top right) demonstrates the sixth embodiment of foot platform with suspension before it is coupled to pedal base of an electric unicycle.

FIG. 9B (isometric view from lower right) and FIG. 9C (view from the front of an electric unicycle) show the sixth embodiment of foot platform with suspension after it is coupled to pedal base of an electric unicycle.

### DETAILED DESCRIPTION OF THE INVENTION

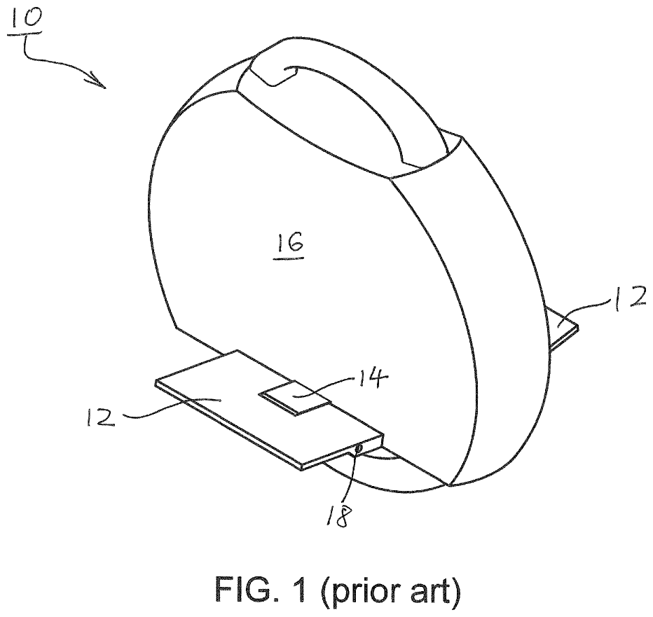

FIG. 1 shows an example of prior art one-wheeled and two-wheeled self-balancing vehicles. The foot platforms 12 are without suspensions. The goal of this disclosure is to provide embodiments of foot platforms with suspension systems for the vehicles.

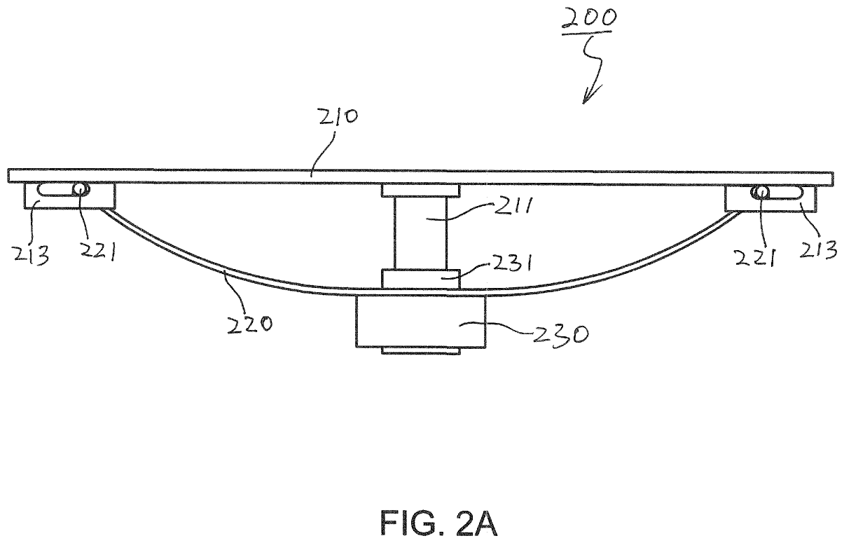

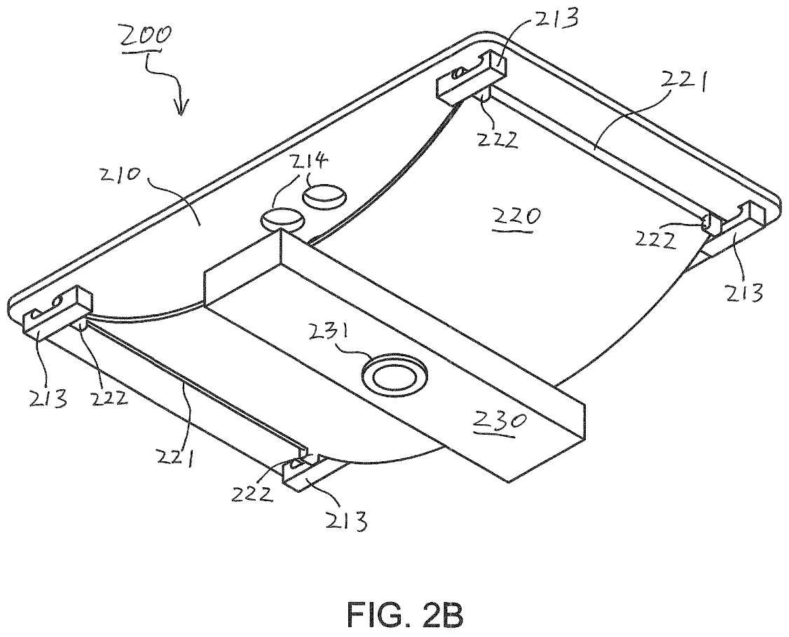

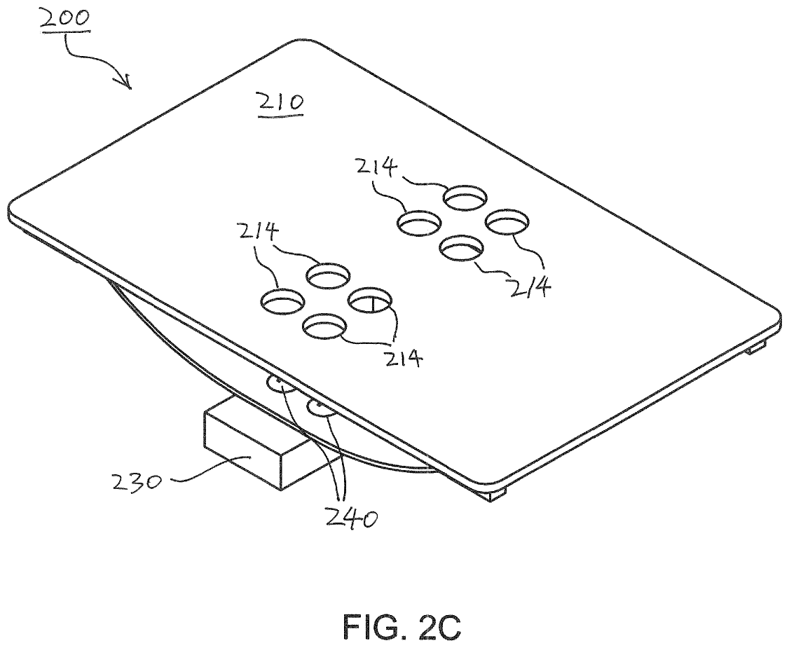

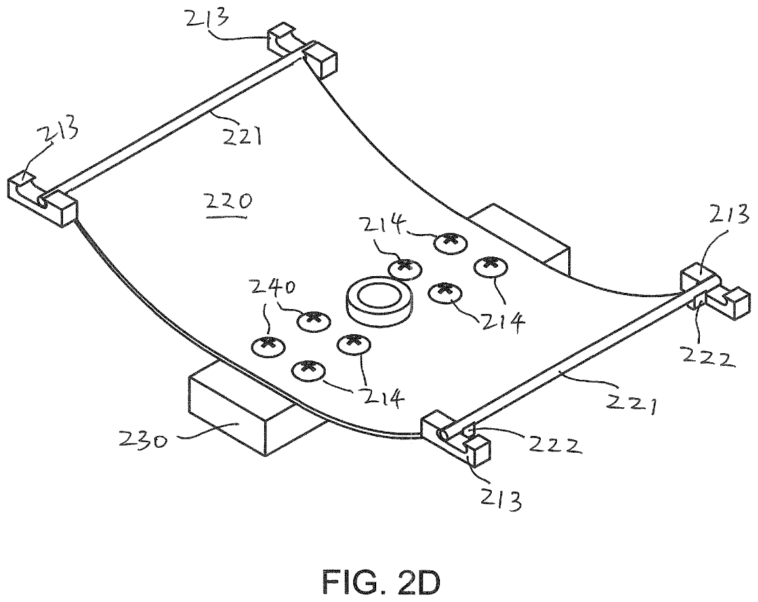

FIGS. 2A-2D: The First Embodiment of Platform with Suspension

FIG. 2A (side view), FIG. 2B (isometric view from lower right), FIG. 2C (isometric view from top right) and FIG. 2D (same as FIG. 2C with the foot platform removed) show the first embodiment of foot platform with suspension 200. It comprises a foot platform 210, a column 211 extruding from the center bottom of the platform 210, a mono leaf spring 220 supporting the foot platform 210, a base 230 with a pipe 231, a slider 221 rigidly connected to the leaf spring 220 at each end. FIG. 2B and FIG. 2D show a plural of slide guides 222 and 213. The slide guides 213 are rigidly fixed on the foot platform 210, while 222 are rigidly connected to 220 and 221. The center of leaf spring 220 is rigidly connected to the base 230 by any method chosen by manufacturers. As an example, FIG. 2C and FIG. 2D show that the leaf spring 220 is fixed on the base 230 by screws 240. The holes 214 in the foot platform 210, shown in FIG. 2B and FIG. 2C, enable users to access screws 240. The base 230 is connected to the vehicle with whatever means vehicle manufacturers choose.

In operation, the driver of the vehicle stands on the foot platform 210, see FIG. 2A. As the vehicle travels, vibrations due to uneven road are sent through the base 230 to the leaf spring 220, and then to the foot platform 210, causing leaf spring 220 to oscillate. As the leaf spring 220 oscillates, sliders 221 slide under the foot platform 210, and the column 211 slides along the pipe 231. Before reaching platform 210, shocks are absorbed and damped by the leaf spring 220 and frictions among sliders 221, 211 and slider guides 221, 231 and 222. The slide guides 213, 222, and the column 211 and the pipe 231 together ensure that the foot platform 210 can only move in directions generally perpendicular to the foot platform 210, satisfying requirement R1). These sliders and slide guides also act as position limiters to keep the device in shape shown in FIG. 2A to 2C.

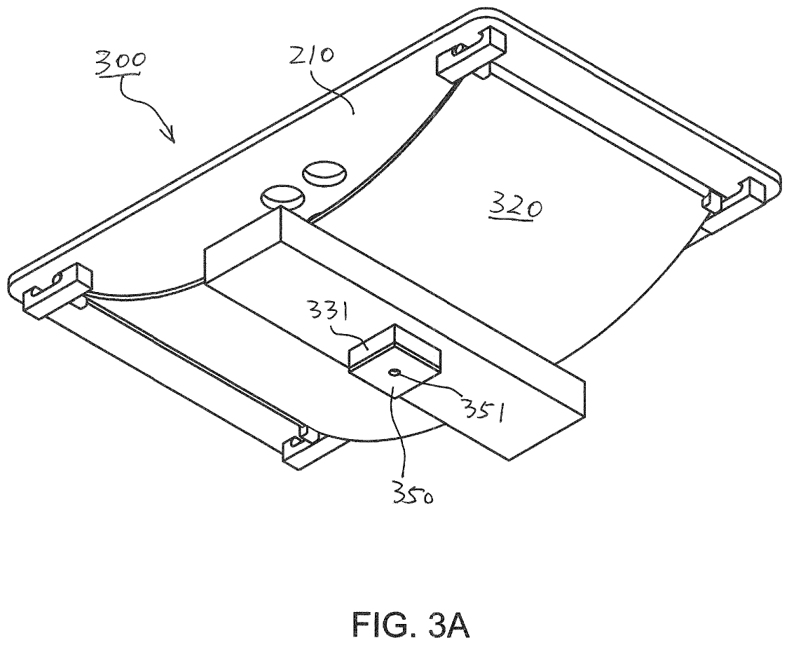

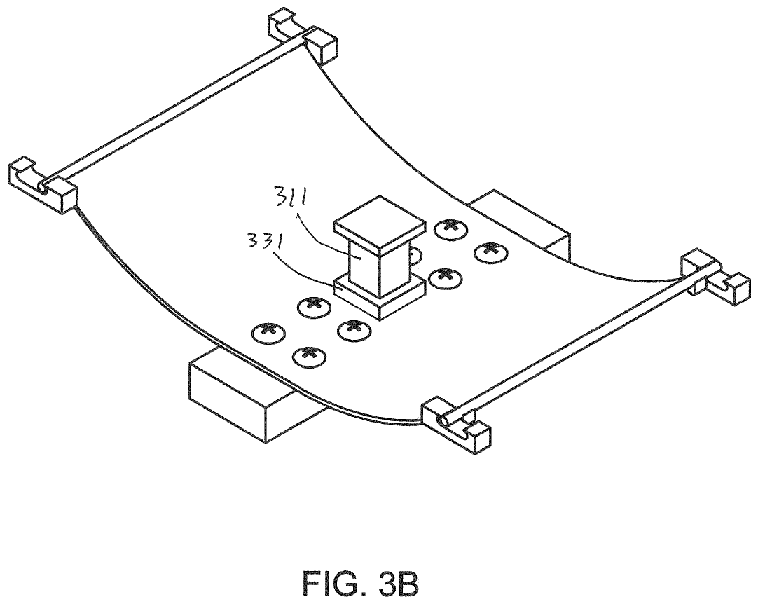

FIGS. 3A and 3B: The Second Embodiment of Platform with Suspension

FIG. 3A (isometric view from the lower right) and FIG. 3B (isometric view from the top right, without the foot platform) illustrate second embodiment 300. Embodiment 300 improves upon the embodiment 200 in two aspects. The first improvement is to replace the circular column 211 and pipe 231 in FIG. 2A by rectangular column 311 and pipe 331 (see FIGS. 3A and 3B), which further prevent the platform 210 from rotating around the column 311. The second improvement is that embodiment 300 has an additional shock damping device, comprising a cover plate 350 at the lower end of pipe 331, and a hole or a plural of holes 351 in the plate 350. As oscillations force the column 311 to slide in the pipe 331, air moves in and out of the pipe through the hole 351. Such air movement provides embodiment 300 with an additional damping mechanism besides dry friction damping. The air damping effect can be adjusted by the size of the hole 351.

Instead of the simple damping device 350 and 351, manufacturers can build other known damping devices, for instance air spring and hydraulic damping, in column 311 and cylinder 331.

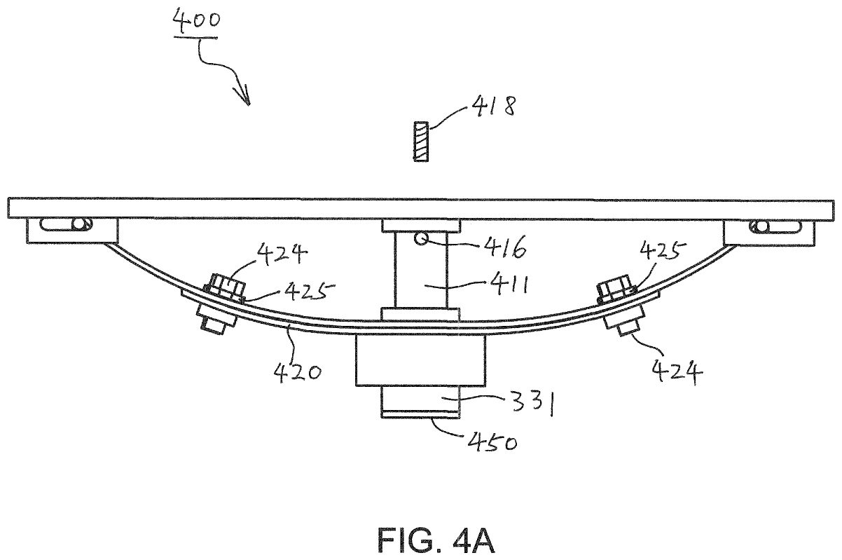

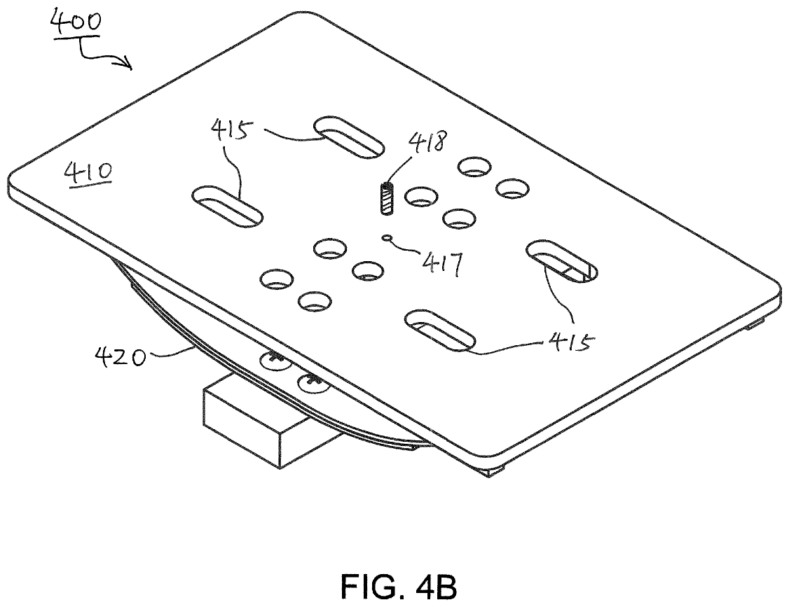

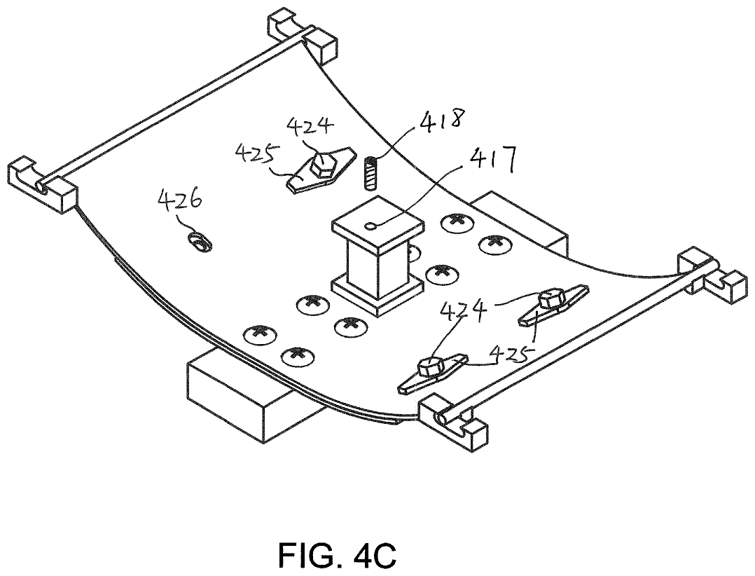

FIGS. 4A-4D: The Third Embodiment of Platform with Suspension

FIG. 4A shows the side view of the third embodiment 400, which improves upon embodiment 300. The embodiment 400 uses multi leaf spring 420, replacing the mono leaf spring 320 (shown in FIG. 3A) in embodiments 200 and 300. Prior art leaf springs use U-bolts squeezing sides of leaves to hold leaves together. However, such method cannot be used in this disclosure because the leaves of 420 are wide and thin. Thus, embodiment 400 uses a plural of screws 424 with tension spacers 425 to hold leaves together. The damping due to friction among leaves of 420 is adjustable by turning screws 424. FIG. 4B is the top right isometric view of this embodiment. The holes 415 on the foot platform 410 enable the user to access screws 424. FIG. 4C is the same view as FIG. 4B, with the foot platform 410 removed, and one of screw 424 removed to show its screw hole 426 in the upper leaf. In operation, as the leaf spring 420 absorbs shocks, leaves of 420 slide relative each other. To enable such sliding, holes 426 in these leaves, except the undermost one, for screws 424 to go through are elongated a little in the direction of sliding.

As is shown in FIG. 4A, the embodiment 400 further improves the embodiment 300 by using plate 450 without a hole in it. The column 411 is hollow inside to reduce the weight. A hole 416 is on the upper part of the slider 411 to allow air to move in and out of the space enclosed by the slider 411, pipe 331 and plate 450. Comparing to embodiment 300, the chance of liquid lubricant, if used, in the pipe 331 to come out is much less due to the position of 416. The screw 418, going through the screw hole 417 (see FIG. 4B) acts as a valve for adjusting the rate of air flow through the outlet 416, which can be used to adjust the damping effect of air movement through the opening 416.

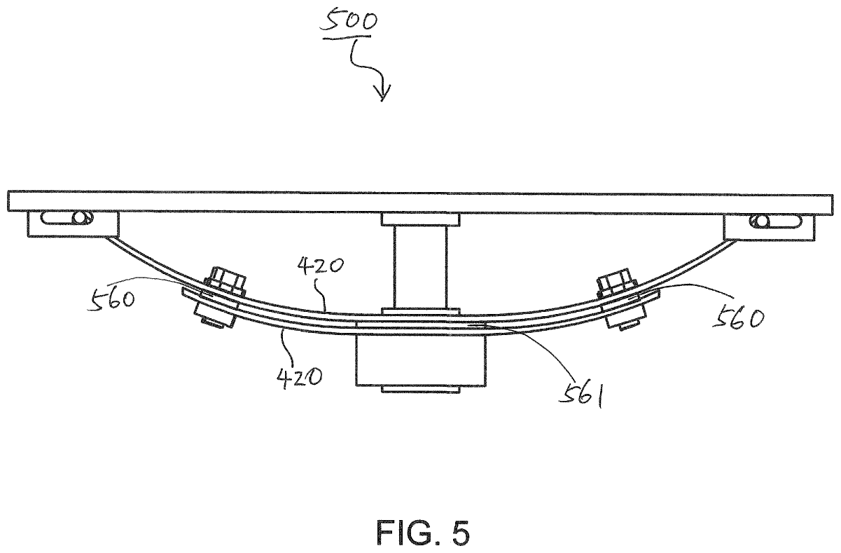

FIG. 5: The Fourth Embodiment of Platform with Suspension

FIG. 5 is the side view of the fourth embodiment 500. The embodiment 500 further improves embodiment 400 by enabling wider range of adjustable damping effect. This is achieved by inserting extra spacer 560 and 561 (see FIG. 5) between leaves of leaf spring 420.

To increase damping, the user can increase the thickness of the spacers 560. Thicker spacers 560 force the lower and upper leaves of 420 to slide longer distance than if without spacers 560. This longer sliding distance increases damping. Difference in thickness of spacers 560 and 561 can be used to create different pre-loadings in leaf spring 420 to satisfy drivers of different weights.

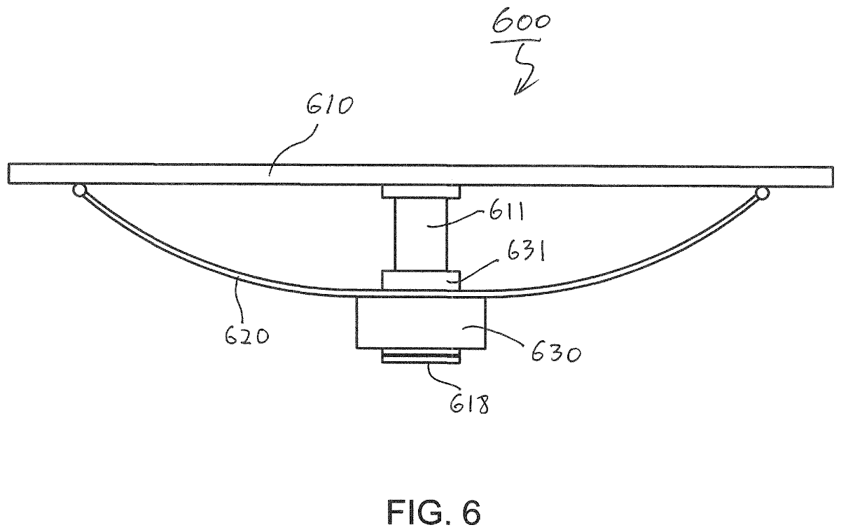

FIG. 6: The Fifth Embodiment of Platform with Suspension

FIG. 6 depicts the side view the fifth embodiment 600. It is a simplification of embodiment 300. It comprises a foot platform 610, a column slider 611 of rectangular cross section protruding from 610, a mono leaf spring 620, a base 630 with a pipe 631 serving as the slide guide for the slider 611. A plate 618 is rigidly coupled at the lower end of the column 611, serving as a position limiter to prevent 611 from sliding out of the pipe from the above.

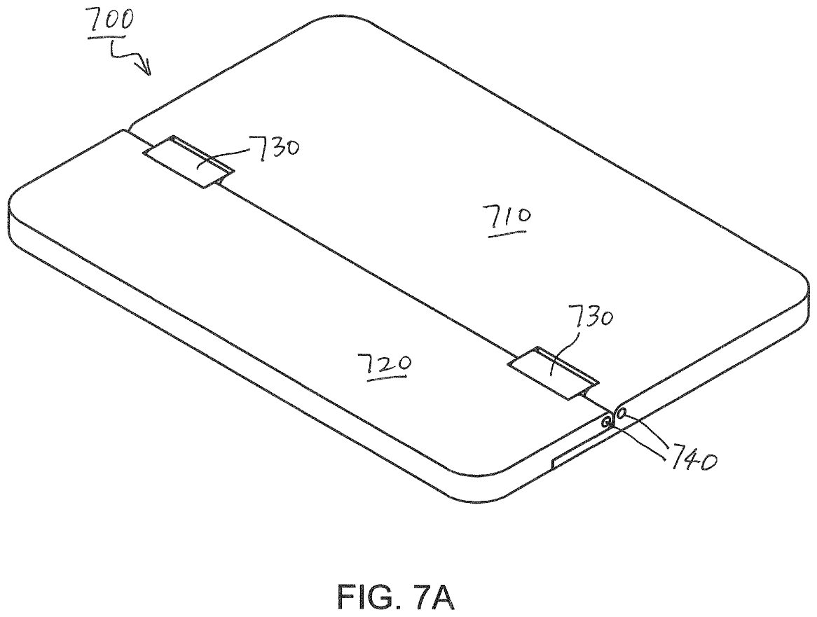

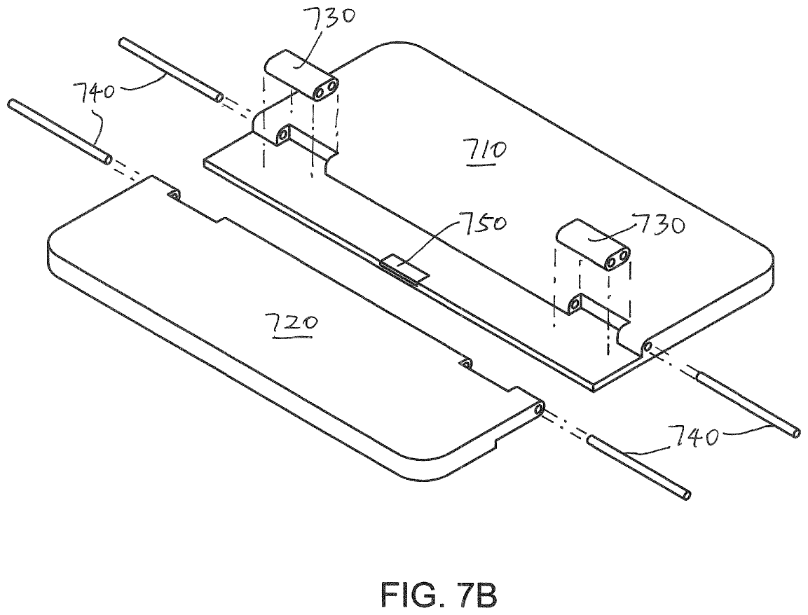

### FIGS. 7A-7B: The First Embodiment of Foldable Platform

FIG. 7A and FIG. 7B (parts blowout drawing) illustrate the embodiment 700 of foldable foot platform that satisfies requirements S1-S4) listed in Paragraph [0009]. The platform consists of two pieces 710 and 720 connected by hinges 730. Each hinge 730 has two axles 740 so that the piece 720 can rotate 180 degrees to lie on top of the piece 710. The magnet 750 shown in FIG. 7B is rigidly attached to the piece 710. The magnet 750 can hold the platform in unfolded flat position when the foot on top of the platform leaves temporally.

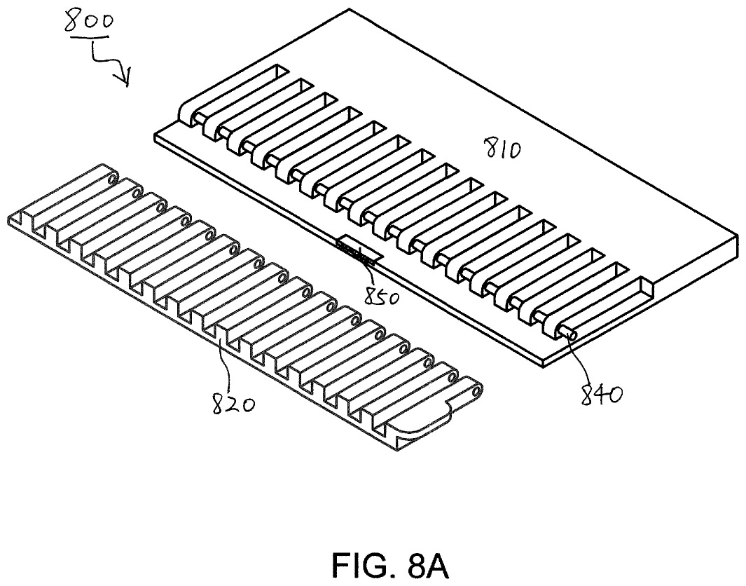

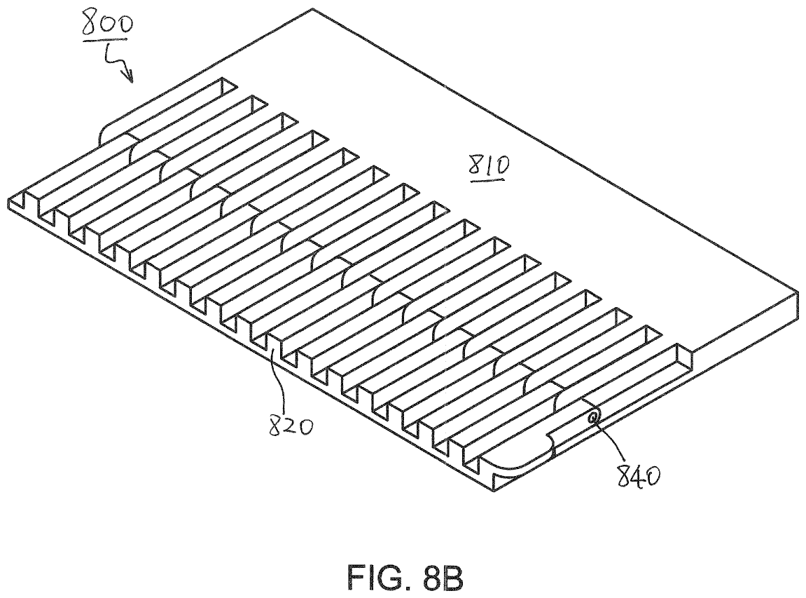

### FIGS. 8A-8B the Second Embodiment of Foldable Platform

FIGS. 8A and 8B show the second embodiment 800 of foldable foot platform before and after assembly respectively. The embodiment satisfies the requirements S1-S4). The two pieces, 810 and 820, of the platform is joined by the axle 840. The shape of the surface of platform pieces 810 and 820 allows the platform in unfolded position to carry weight on top of it. The magnet 850 rigidly fixed on 810 is for holding the platform in flat unfolded position when the foot on top of the platform temporarily lose contact with the platform. The trenches on pieces 810 and 820 allows the piece 820 to rotate around the axel 840 to lie on top of 810 when folded. These trenches are narrow enough so that they increase the foot grip without causing discomfort in foot.

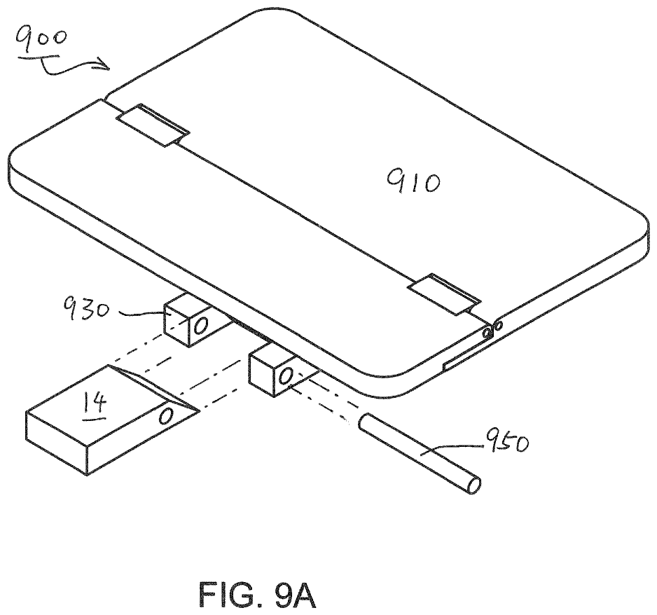

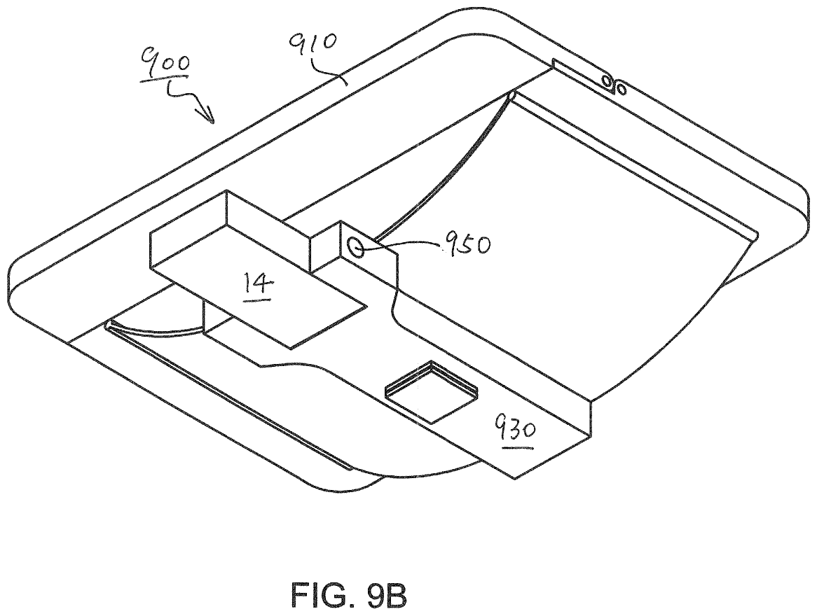

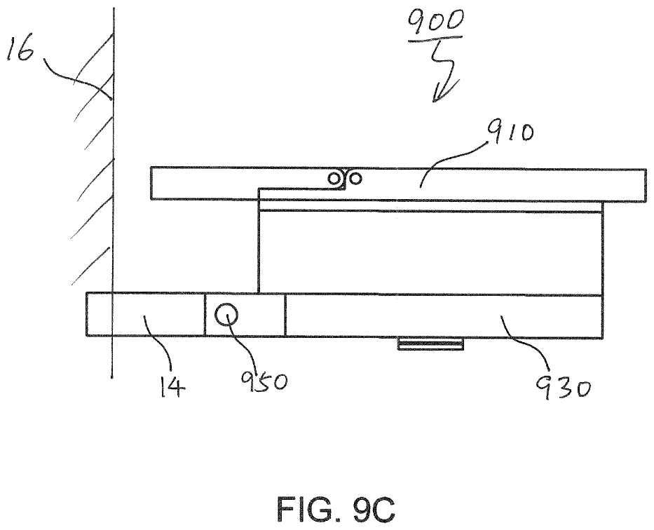

FIG. 9A to 9C: The Sixth Embodiment of Platform with Suspension, Designed for Electric Unicycles

FIG. 9A (isometric view from top right) shows embodiment 900 of foot platform with suspension for electric unicycles, before the embodiment 900 is joined to the electric unicycle. This embodiment is a modification of embodiment 600 for using in electric unicycles. The modifications are replacing the platform 610 and the base 630 of embodiment 600, shown in FIG. 6, by a foldable platform 910 and base 930 respectively. The foldable platform 910 illustrated is embodiment 700. The base 930 is to be joined to the pedal arm 14 of an electric unicycle by the axle 950. See FIG. 1 for the location of the pedal arm 14.

FIG. 9B (isometric view from lower right) shows the embodiment 900 after its base 930 is attached to pedal arm 14 of an electric unicycle. The embodiment 900 can turn around the axle 950 counterclockwise to vertical position relative to the pedal arm 14 for compactness when not in use.

FIG. 9C (view from the front of the electric unicycle) illustrate embodiment 900 after it is mounted on the pedal arm 14 of the vehicle. After the left part of the foot platform 910 is folded by turning it clockwise 180 degrees, the embodiment 900 can be turned counterclockwise around the axel 950 to be parallel to the casing wall 16 of the vehicle, see also FIG. 1. This will make the vehicle more portable when not in use.

### Advantages:

From the description above, a number of advantages of proposed embodiments of foot platform with suspension systems become evident.
(a) These embodiments are low in height, compact in size. They are modules whose only connection to the vehicle's main body is the base 230 (see FIG. 2B). Manufactures of known one and two wheeled self-balancing vehicles can adapt these embodiments without major structural change in their existing products. FIGS. 9A-9C demonstrate that retro-fitting existing self-balancing unicycles 10 shown in FIG. 1 with embodiment 900 is a simple matter of replacing the existing foot pedals 12 by embodiment 900 (see FIG. 9A).
(b) The interference of the embodiments to the steering of self-balanced vehicles is minimum. This is because the embodiments disallow any rotational and horizontal movements of foot platform relative to the vehicles main body, which would induce unwanted drivers' body lean and change the balance.
(c) These embodiments are easy and inexpensive to manufacture. This is because they are simple in structure, and high precision is not required.
(d) These embodiments are compact in size and light in weight to keep the self-balancing vehicles portable.
(e) These embodiments are reliable because they have few moving parts. They are easy to maintain because adjusting damping or changing parts is as easy as turning some screws accessible from the outside of the vehicles.
(f) These embodiments are easily isolated away from other parts of the vehicles, such as battery packs and electronics, to achieve better reliability.
(g) Some embodiments allow users to change the leaf springs, the pre-loading and damping to satisfy various users' personal preferences.
(h) These embodiments can be used in other devices when requirements R1) to R4) are desired.

The advantages of embodiments 700 and 800 of foldable platform are that they satisfy S1-S4), and they are thin and simple. They can be used as foot platforms in the vehicles.

The descriptions above contain many specificities. These specificities should not be constructed as limiting the scope of the embodiments but as merely providing illustrations of some preferred embodiments. Features of the embodiments described above can be easily regrouped to form more embodiments. Another way to make new embodiments is flipping leaf springs upside down in embodiments disclosed above as long as they can push the bases and platforms apart. If there is no danger of column slider 611 (see FIG. 6) to lose contact with the slide guide 631, the position limiter in 618 in the embodiment 600 can be eliminated to form a simpler embodiment. Thus, the scope of the embodiments should be determined by the appended claims and their legal equivalents, rather than by the examples given.

What is claimed is:

1. A foldable platform, comprising
a) at least one pair of pieces of platforms, with protruding part in one piece and supplementary part on the other piece so that said pieces, when joined by a hinge or hinges, form a platform in completely unfolded position that can resist force in unfolding directions;
b) at least one hinge consisting of two parallel cylinders rigidly joined together, with one axle through each of said cylinders to join said pieces of platform, so that there is no part protruding the surface of platform in unfolded position;
c) a plural of holes in said pieces of platform for housing said axels of said hinge or hinges.

2. The foldable platform of claim 1, further comprising at least one magnet rigidly mounted on at least one of said pieces of platform for holding the platform in unfolded position against small disturbances.

3. A foldable platform, comprising
a) at least two piece of platforms, with alternating trenches on each of them to allow folding, and holes for one axel to join two pieces, so that there is nothing protruding the general surface of the platform when unfolded;
b) at least one axle to join said pieces of platform.

4. The foldable platform of claim 3, further comprising at least one magnet rigidly mounted on at least one of said pieces of platform for holding the platform in unfolded position against small disturbances.

5. A platform with a suspension system, comprising:
a) a platform, either foldable or non-foldable, having a column or a plural of parallel columns of any cross section shape rigidly coupled to said platform;
b) a base having a pipe for each said column to slide in said pipe;
c) at least one leaf spring between said platform and said base for absorbing and damping vibrations propagating between said base and said platform;
d) a plural of sliders and slider guides mounted on said platform and or said leaf spring or springs for preventing said platform from rotating, if the number of said column is one and if the cross section of said column is circular.

6. The platform with a suspension system of claim 5, further comprising at least one position limiter to prevent said column or columns from exiting said pipe or pipes.

7. The platform with a suspension system of claim 5, further comprising a plural of sliders and slide guides mounted on said platform, and/or on said leaf spring or leaf springs, and/or on said base.

8. The platform with a suspension system of claim 5, further comprising at least one cover rigidly mounted at the bottom of at least one of said pipe.

9. The platform with a suspension system of claim 8, further comprising a path for air to travel between the outside and inside of the space enclosed by said pipe, said column and said cover.

10. The platform with a suspension system of claim 9, further comprising a valve for adjusting the air flow rate of said air path.

11. The platform with a suspension system of claim 5, wherein said leaf spring or a plural of leaf springs are multi-leaf spring or springs, further comprising a plural of screws for the purpose of holding leaves of each said multi-leaf springs together while allowing leaves to slide relative to each other as said multi leaf spring or springs oscillate, and for adjusting the compressing tension among said leaves.

12. The platform with suspension system of claim 11, further comprising a cover rigidly coupled to the bottom of said pipe or pipes.

13. The platform with a suspension system of claim 12, further comprising a path for air to travel between the outside and inside of the space enclosed by said pipe, said column and said cover.

14. The platform with a suspension system of claim 13, further comprising a valve for adjusting the air flow rate of said air path.

15. The platform with a suspension system of claim 11, further comprising a spacer or a plural of spacers on at least one side of leaves or between leaves of springs.

16. The platform with suspension system of claim 15, further comprising a cover rigidly coupled to the bottom of said pipe or pipes.

17. The platform with a suspension system of claim 16, further comprising a path for air to travel between the outside and inside of the space enclosed by said pipe, said column and said cover.

18. The platform with a suspension system of claim 17, further comprising a valve for adjusting the air flow rate of said air path.
